(19) United States
(12) Patent Application Publication
(10) Pub. No.: US 2003/0085898 A1
(43) Pub. Date: May 8, 2003

(54) Display device with manually changeable characters

(76) Inventor: Hamid Yahyapour, Tempe, AZ (US)

Correspondence Address: GREGORY J. NELSON, NELSON & ROEDIGER, Suite 212, 3333 E. Camelback Road, PHOENIX, AZ, 85018, US

(21) Appl. No.: 10/008,940

(22) Filed: Nov. 8, 2001

(51) Int. Cl. G06T 11/00

(52) U.S. Cl. 345/467

(57) ABSTRACT

A display having character sets with segments arranged on a panel in a manner similar to digital displays. The segments are secured on the board by elastic cords or bands so they may be manually positioned to display a selected side to form a number or letter. Multiple character sets may be provided on the panel front surface as well as on the surface of an opposite panel.

### FIELD OF THE INVENTION

The present invention relates to a display device and more particularly relates to a sign having one or more character sets which are each comprised of segments arranged similar to an electronic digital display, which segments may be manually positioned to form selected alphanumeric characters.

### BACKGROUND OF THE INVENTION

There are many types of signs which display alphanumeric characters and which may be changed to the score of an athletic contest or the number of a particular contestant or player. In some instances, these signs or displays are sophisticated electronic devices which are expensive, are generally permanently installed and do not lend themselves to portability.

However, there are many applications in which signs are required to display information as sports scores, prices, interest rates and similar information which sign should be portable, inexpensive and easy to operate. There are various approaches in the prior art that provide signs displaying characters which are manually changeable and which are not electronic. For example, U.S. Pat. No. 4,220,948 shows a sign board which comprises an opaque front plate interfacing with a translucent or reflective back plate. Slots in the front plate define the segments of seven segment characters. Shutters are slidable to selectively open and close the slots to define individual characters. Means are provided for containing the shutters in open and closed positions.

U.S. Pat. No. 4,251,936 shows a display unit in which a frame assembly magnetically supports a plurality of removable display strips in predetermined patterns which alphanumeric character elements are magnetically supported on the display strips and frame assembly in information displaying sets referenced, in part, by markings located on the surface of the display strips.

U.S. Pat. No. 4,729,184 shows a manually changeable display device capable of displaying the numerals 0 through 9 having a background panel with an optic or brightly colored face and a one-piece foreground panel adjacent to and parallel with the background panel. The one-piece foreground panel has seven elongated windows or openings which expose seven corresponding segments of the background panel. Each of the windows is covered by a flap which integrally formed with the foregoing panel and is hinged thereto. The desired numerals are formed by opening and closing the appropriate flaps to expose the corresponding segment. Two or more display units can be arranged side-by-side to displayed the numerals 10 and above.

U.S. Pat. No. 5,481,816 shows a sign displaying characters in a manner emulating a digital display and the characters are formed using character elements to define parts of a particular font of characters. The sign defines particular characters by covering the character elements not required for that character. The digital characters are formed on one or more sign inserts that removably fit within a sign body. The sign body includes a window exposing a view of the character elements of each insert. The sign inserts may be a ferrous material that cover members of magnetic material so that the cover members are readily repositionable to change the message display by the visual character.

From the foregoing, it will be appreciated that the prior art approach to providing display signs or message board with changeable characters is to use various types of inserts, magnetic attachments or windows which may be selectively opened and closed to display the desired character.

Accordingly, there exists a need for an improved, inexpensive and convenient to use manually changeable sign or score board.

It is an object of the present invention to provide a display which may be readily and easily changeable manually in order to display desired character sets having the numerals 0 through 9.

It is a further object of the present invention to provide a display which is simple, rugged and durable and which may be used for such purposes as a score board at athletic contests.

It is another object of the present invention to provide a display that has the appearance of a digital style, electronic display and yet is manual so that it is inexpensive and does not require sophisticated circuitry and a power source.

It is another object of the present invention to provide a display device having character display units which may be easily positioned and manipulated to display the numerals 0 through 9 and having multiple character display units so that, for example, two or three digit numbers may be displayed.

### BRIEF SUMMARY OF THE INVENTION

Briefly, the present invention relates to a display device having a mounting board or panel on which one or more character display sets are mounted. Each of the character display sets comprises a plurality of individual, alphanumeric-forming segments. For example, the segments may be arranged in a font or style of the type commonly used in electronic displays. Each of the segments is trapezoidal having the shape of an elongated bar with tapered ends. The ends of each of the segments are attached to an elastomeric member such as an elastic cord or band which extends through an aperture in the board. The elastic cords or bands may be secured at the rear side of the board. A rear panel extends over the back of the mounting panel. The individual segments have one surface which corresponds to the color of the surface of the mounting panel which typically would be a dark background color. The opposite or obverse side of the segments are preferably brightly colored for visibility in a color such as a flourescent or retroreflective color. The individual segments are manually positioned by grasping the individual segments and pulling them away from the board and rotating them to selectively expose one side or the other to form the desired character. Multiple characters sets may be provided so that two, or even three, numerals may be displayed.

In an alternate embodiment, both the front and rear surface of the sign are provided with character segments and elastic bands extend through openings in the board to attach to the segments on opposite sides of the mounting board. Thus, the display may be manipulated to present the same or different numbers on the opposite sides.

The display is portable and may be provided with a transparent, protective cover as well as a stand so that it may be prominently displayed on a location such as an athletic field.

The sign may be used to display prices, rates and has particular application to athletic events such as displaying scores or numbers of players entering or leaving a particular athletic contest, such as a soccer game.

### BRIEF DESCRIPTION OF THE DRAWINGS

The above and other objects and advantages of the present invention will be more apparent from the following description, claims and drawings in which:

FIG. 1 is a perspective view of the display sign of the present invention showing the segments positioned with the numeral 59 displayed;

FIG. 2 is a front view of the display sign of the present invention;

FIG. 3 is a perspective view of the sign illustrating one of the characters segments in a rotative position;

FIG. 4 is a view similar to FIG. 3 showing the second set of characters on the side of the mounting board opposite the front side, the second set being shown in dotted lines;

FIG. 5 is a front view of an embodiment of the present invention in which the displays sign is incorporated into an athletic score board;

FIG. 6 illustrates another embodiment of the present invention which the sign is provided with a transparent weather-protective cover;

FIG. 7 shows the sign of the display sign of the present invention supported on a standard or display;

FIG. 8 is a partial cross-section view of the display sign of the present invention in which character segments are provided on both sides of the sign.

FIG. 9 is a partial cross-section view showing an embodiment of the display sign having display characters on a single side; and

### DETAILED DESCRIPTION OF THE DRAWINGS

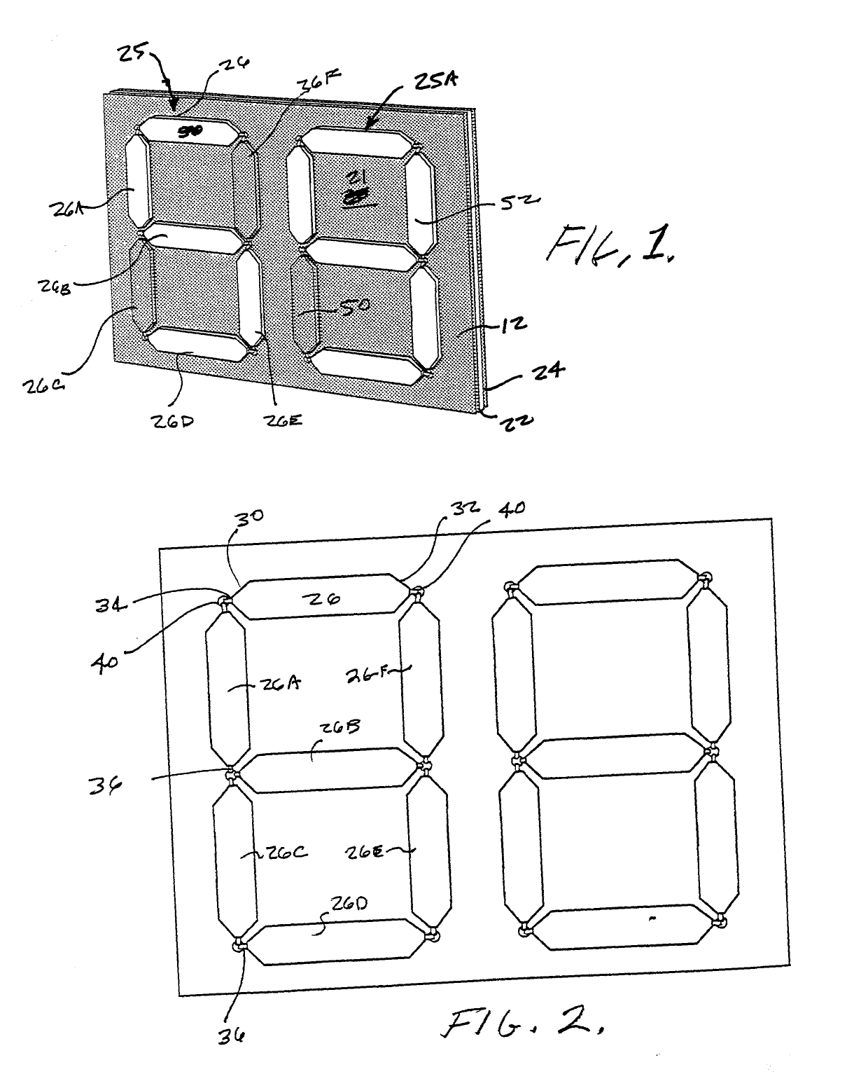

Turning now to the drawings, particularly FIGS. 1 to 4 and 9, the display of the present invention is generally designated by the numeral 10 and includes a front mounting panel 12 which is shown as being generally rectangular having opposite side edges 14, 16, top 18 and bottom edge 20. However, it will be appreciated that the shape of the board may be any desired geometric shape.

Display 10 is a laminate structure having a front panel or board 12, an intermediate panel 22 and a rear panel 24 laminated or otherwise secured to the rear surface of the front panel. The panels may be of any suitable material such as paperboard, cardboard, fiberboard or plastic. It is preferred that the panels be fabricated from an inexpensive, yet durable, material such as a corrugated material which is coated and impregnated with polymeric material providing lightweight and durability for outdoor use. Preferably, the front surface 21 of the front panel 12 is a dark, light-absorbing color such as black, which will provide a background for better visibility of the characters on the panel.

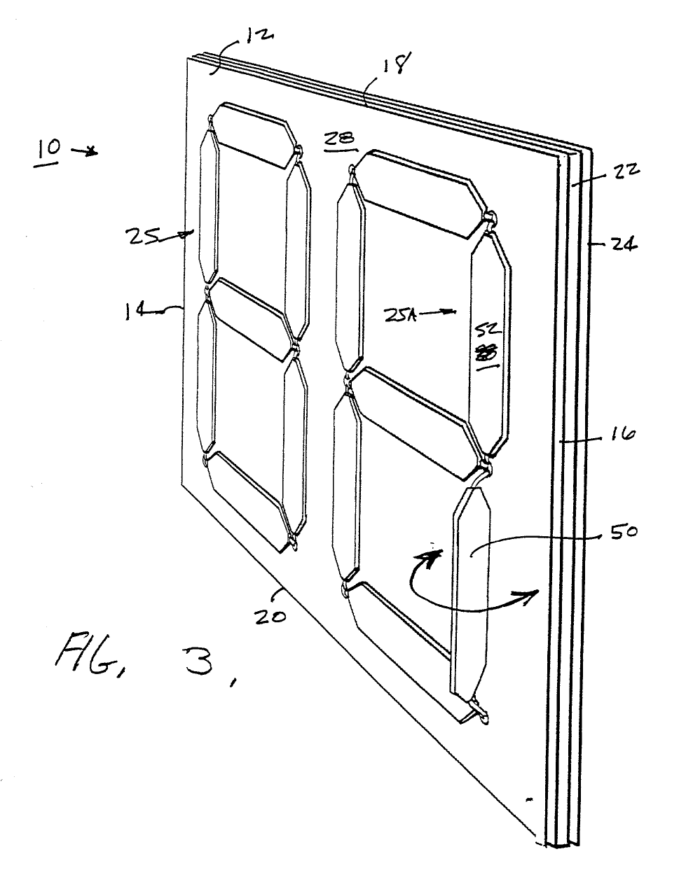

As shown in FIGS. 1 and 2, multiple character display sets 25 and 25A are provided on the front surface 21. Each of the display sets, as for example display set 25, is comprised of a number of individual display character segments 26 through 26F. Each of the segments is generally an elongated trapezoidal shape having ends 30 and 32 which taper to form an apex 34. The segments are arranged in an arrangement similar to conventional digital display which allows various alphanumeric characters to be selectively formed. The conventional seven segment display allows the numerals 0 to 9 to be displayed, as well as some letters.

Adjacent the tip or apex of each segment is a bore 40 which extends through the mounting panel 12. The apex of each of the segments 26 through 26F are attached to an elastomeric member such as an elastic band or cord 36. The band or cord 36 may be attached to the segments by mechanical means, such as a staple, or an adhesive applied to the apex of the individual segments. The cords extend through the bore 40 adjacent the tip of the characters and, as seen in FIG. 9, are secured at a location intermediate the front and rear panel as by means such as a knot 44 tied in the end of the cord so that the cord will not be pulled through the bore 40. The cord can be secured by other means as well.

The individual character segments 26 have a first surface 50 which is colored to match the color, and preferably the texture of the surface 21 of front panel 12. The obverse surface 52 of each of the segments is a contrasting color which, for visibility, is preferably a bright, flourescent or retroreflective color. Thus, as seen in the lefthand part of FIG. 1, character elements 26F and 26C are positioned so that their surfaces 50 are exposed making them less visible against the similar background of the surface 21 of mounting panel 12. Character segments 26, 26A, 26B, 26E and 26D are positioned with their brightly colored, obverse surfaces 52 in an outward viewing position. Other segments in character display set 25A are arranged so that the numeral 3 is visible, the two sets combining to display 59.

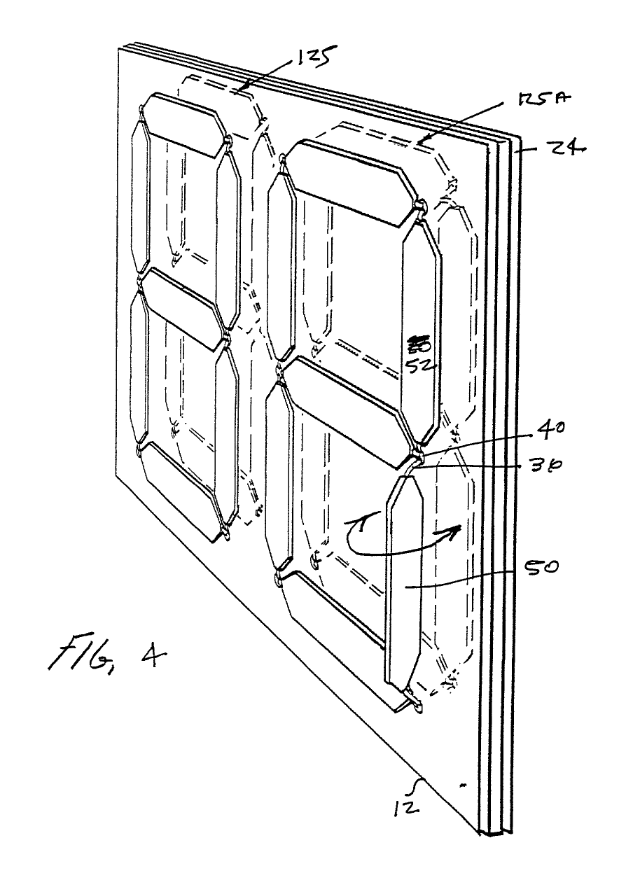

Referring to FIGS. 3 and 4, it will be apparent that the individual segments may be manipulated to selectively display either surface 50 or 52 by simply manually grasping the individual segments and pulling them away from the board against the retention force exerted by the bands 36 and rotating them as required. The elastomeric bands 36 facilitate easy rotation and when the segments are released, they will be firmly held against the front surface 28 of the board 12 by the force exerted by the bands.

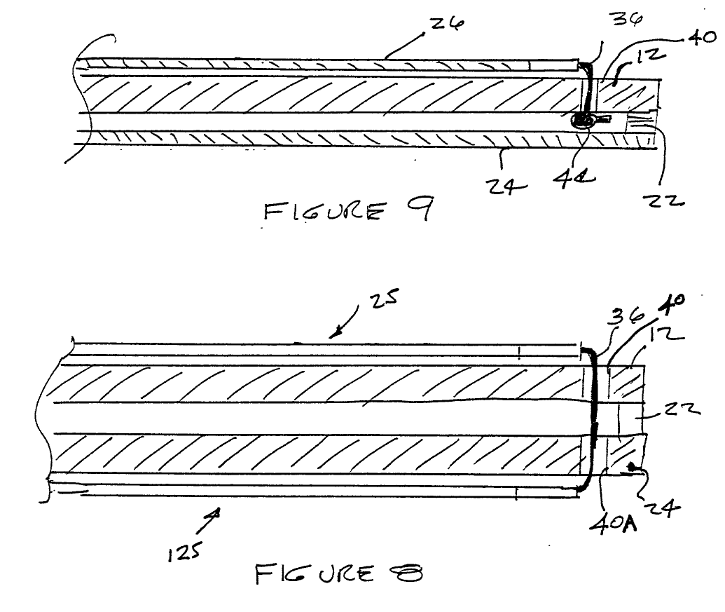

Referring to FIGS. 4 and 8, an alternate embodiment of the invention is shown in which additional character display sets 125A, 125B are provided on the surface 24 of the board. These character display sets are also each comprised of a plurality of segments 26 to 26F, each arranged immediately opposite display character sets 25, 25A on panel 12. Elastomeric members 36 extend through openings 40 in the front and 40A in the rear panel and oppositely attach to the ends of the various segments. In this embodiment, the elastomeric cords or bands 36 are not terminated or tied-off at a location at the rear of the panel 12, but rather attach to adjacent segments to provide adjustability to the segments located on both sides of the display 10.

Referring to FIG. 5, a score board 100 is shown which may be fabricated from any suitable material having frames 102, 104. Each of the frames 102, 104 receive a display 10 as shown in FIG. 1. The score board is further provided with indicia indicating that it is a score board and bearing the legend “Home” and “Visitor” immediately above the frames. Thus, in this embodiment, the segment sets 25, 25A in each display may be manipulated to indicate the score of the home and visiting team and may be manually changed during the course of an athletic event.

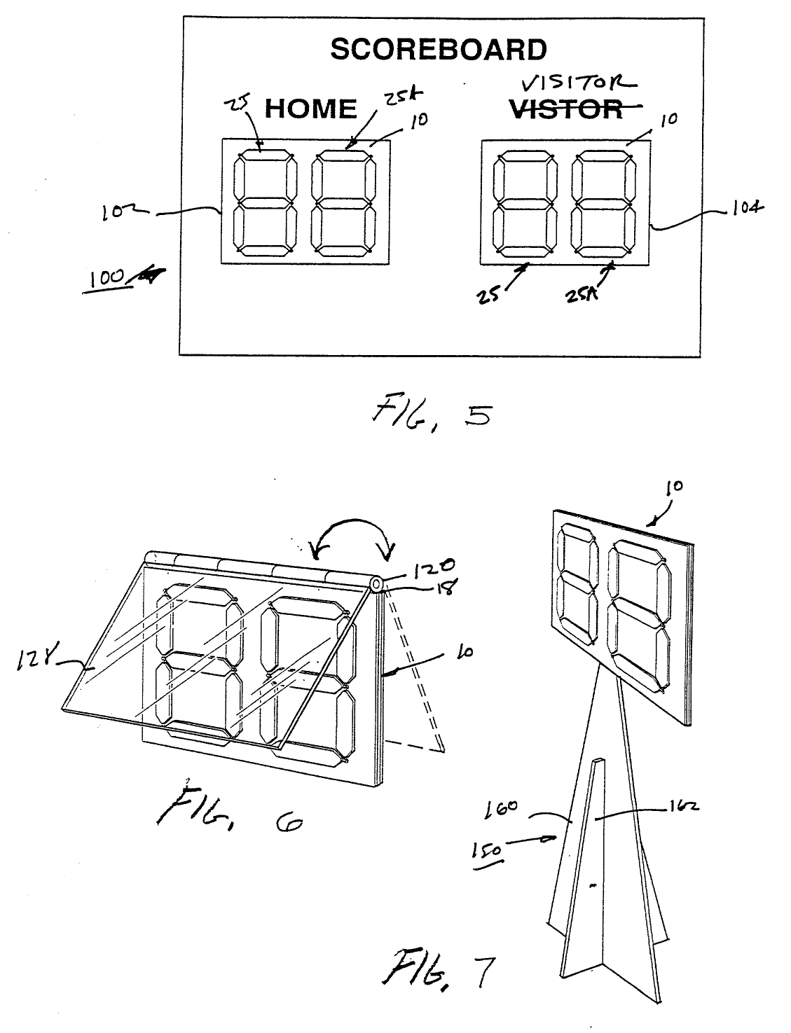

In FIG. 6, the alphanumeric display 10 is as shown in FIG. 1 further provided with a hinge 120 extending along the upper edge 18 of the panel. The hinge pivotally supports a transparent panel 128 of a suitable plastic material such as Lucite which has been treated with a UV agent. The transparent display can be positioned over the face of the sign to protect against environmental conditions such as rain or snow. When it is desired to manually change the characters, the panel can be pivoted upwardly and changing the character sets may be manually accomplished.

In FIG. 7, the display 10 is provided with a base or stand 150 on which the display rests. Preferably the stand has legs 160 and 162 which are inter-engaged in a slot in legs 162. The legs may be detached for portability and storage.

Thus it will be seen from the foregoing, the present invention provides a highly versatile display which may be used to display various numbers and letters. The sign can be made from expensive materials and is suitable for events such as Little League athletic events allowing an individual or scorer in charge of the board to easily reposition the characters sets as the event progresses. For example, the sign may be used as a score board to display “Home” or “Visitor” scores or an event such as a soccer event and may be positioned to indicate the number of a player entering the game and on the opposite side the number of the player leaving the game. Preferably, the display or viewing surface of the individual segments are brightly colored of flourescent.

It will be obvious to those skilled in the art to make various changes, alterations and modifications to the invention described herein. To the extent these various changes, alterations and modifications do not depart from the spirit and scope of the appended claims, they are intended to be encompassed therein.

I claim:

1. A display comprising:
(a) a first panel having a front surface and a rear surface;
(b) at least one character set on said front surface, said character set comprising segments arranged in a manner corresponding to a digital display;
(c) each of said segments being a generally elongated geometric shape having opposite ends, said ends being secured to said board by elastomeric members;
(d) said segments having a first surface in a first color and an opposite second surface having a color corresponding to the color of the front surface of the first panel whereby a user may rotate individual segments to position the reverse and obverse segment surfaces to establish selected alphanumeric characters.

2. The display of claim 1 wherein a second panel is secured to the rear surface of said first panel having a front and rear surface.

3. The display of claim 1 wherein said first panel carries multiple character sets.

4. The display of claim 1 wherein said second panel is provided with:
(a) at least one character set on said front surface, said character set comprising of segments arranged in a manner corresponding to a digital display;
(b) each of said segments being a generally elongated geometric shape having opposite ends, said ends being secured to said board by elastomeric members; and
(c) said segments having a first surface in a first color and an opposite second surface having a color similar to the color of the front surface of the second panel whereby a user may rotate individual segments to position the reverse and obverse segment surfaces to establish selected alphanumeric characters.

5. The display of claim 1 wherein said display further includes a frame.

6. The display of claim 1 wherein said panel is fabricated from the group of materials consisting of plastic, cardboard, fiberboard and corrugated board.

7. The display of claim 1 further including a transparent cover extending over said first panel.

8. The display of claim 1 wherein said first color on the first surface of said segments is a flourescent color and said second color on said second surface is a dark color.

9. The display of claim 1 wherein said character set comprises seven segments.

10. The display of claim 1 further including a stand supporting said display.
